(19) United States
(12) Patent Application Publication
(10) Pub. No.: US 2007/0089140 A1
(43) Pub. Date: Apr. 19, 2007

(54) CHANNEL SETTING SYSTEM AND METHOD

(75) Inventors: Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,519

(22) Filed: Aug. 16, 2006

(30) Foreign Application Priority Data
Oct. 14, 2005 (CN) 200510100370.3

(51) Int. Cl. H04N 5/445; G06F 3/00; G06F 13/00

(52) U.S. Cl. 725/56; 725/46; 725/39

(57) ABSTRACT

A channel setting system is provided. The system is used in an electronic device and includes an input unit for receiving operational inputs; a timer for tracking an elapsed time when the electronic device is activated on a channel; and a control unit for calculating a total playing time of each channel during a time interval according to the elapsed time of the timer, and generating a channel playlist comprising a favorite channel sublist for each time interval based on the total playing time of each channel. A channel setting method is also provided.

### TECHNICAL FIELD

The present invention relates to channel controlling systems and methods, and particularly to a channel setting system and method.

### GENERAL BACKGROUND

Favorite channel lists are becoming a common feature on television (TV) systems and Internet browsing applications. For example, present digital satellite system (DSS) set-top boxes provide favorite TV channel lists that support a user specifically selecting a set of favorite channels. Likewise, Internet web browsers such as Netscape Navigator, and Microsoft Internet Explorer allow the user to specifically select a set of favorite channels.

The presently available favorite channel lists are created by the user specifically selecting which channels are to be in the favorite channel list. For example, most DSS set-top boxes will display user interfaces for specifying a channel and adding it to the favorite channel list. However, creating the favorite channel list initially takes time for the user. Additionally, to maintain an up-to-date favorite channel list, the user must continually add or remove channels to/from the favorite channel list.

Accordingly, what is needed is a channel setting system and method that can automatically build the favorite channel list, in order to overcome the above-described problems.

### SUMMARY

A channel setting system is provided. The channel setting system is used in an electronic device and includes an input unit for receiving operational inputs; a timer for tracking an elapsed time when the electronic device is activated on a channel; and a control unit for calculating a total playing time of each channel during a time interval according to the elapsed time of the timer, and generating a channel playlist comprising a favorite channel sublist for each time interval based on the total playing time of each channel.

A channel setting method is also provided. The channel setting method is performed on an electronic device, and includes the steps of: (a) tracking an elapsed time when the electronic device is activated on a channel; (b) calculating a total playing time of each channel according to the elapsed time during a time interval; and (c) generating a channel playlist comprising a favorite channel sublist for each time interval according to the total playing time of each channel.

Other advantages and novel features will be drawn from the following detailed description of the embodiments with reference to the attached drawings, in which:

### BRIEF DESCRIPTION OF DRAWINGS

FIG. 1 is a block diagram of a hardware infrastructure of a channel setting system in accordance with a preferred embodiment of the present invention;

FIG. 2 is a schematic diagram of the favorite channel list of FIG. 1;

FIG. 3 is a flowchart of generating favorite channel lists of a preferred channel setting method by implementing the system of FIG. 1; and

FIG. 4 is a flowchart of playing a channel according to an favorite channel list of the preferred channel setting method.

### DETAILED DESCRIPTION OF PREFERRED EMBODIMENT

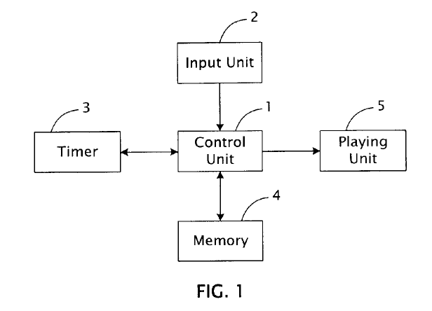

FIG. 1 is a block diagram of a hardware infrastructure of a channel setting system (hereafter, “the system,”) in accordance with a preferred embodiment of the present invention. The system can be used in any electronic device including, but not limited to, a television (TV), a broadcast, a wireless receiver, and so forth. For simplicity, in the preferred embodiment, the following description will be provided with respect to a TV as the electronic device.

The system includes a control unit 1, an input unit 2, a timer 3, a memory 4, and a playing unit 5. The timer 3 tracks an elapsed time when the playing unit 5 plays a particular channel. When switched to another channel, the timer 3 resets the elapsed time.

The memory 4 stores information used or generated by the TV. The information includes descriptions of each channel, playing records of each channel in a corresponding time span, and channel playlists for each corresponding time span generated according to the playing records of each channel.

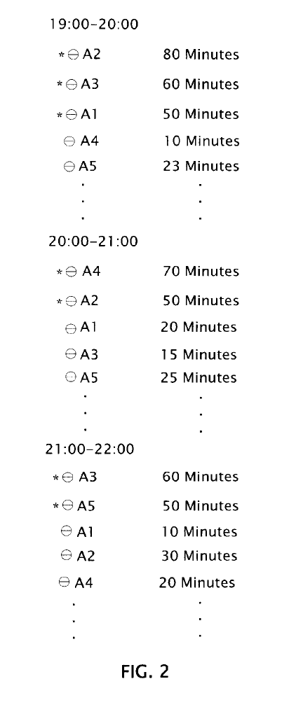

Each of the playing records includes a playing frequency of an associated channel, playing time of the associated channel, and a total playing time of the associated channel. The description of each channel includes a channel number (such as, A1, A2, A3, and A4) and a corresponding channel name. The channel playlist consists of a favorite channel sublist and a general channel sublist. The favorite channel sublist includes one or more favorite channels, whereas the general channel sublist includes one or more general channels. The favorite channels are channels whose total playing time is greater than a preset time value, conversely, the general channel channels are channels whose total playing time is less than or equal to the preset time value. Furthermore, the favorite channels each are highlighted with an appropriate symbol, thereby distinguishable from the general channels. For example, in the embodiment as that shown in FIG. 2, the favorite channels are highlighted with a symbol “*”. Moreover, the favorite channels are arranged in a descending order in the favorite channel sublist, according to the total playing time associated therewith. General channels are in a stochastic order in the general channel sublist.

The playing unit 5 is provided for playing audio signals and video signals in each channel.

The input unit 2 includes all the commonly used keys such as a turn on/off key, one or more numbered keys for tuning a channel, keys for adjusting volume, up/down keys, and so on.

The control unit 1 generates the channel playlist according to the total playing time of each channel in a corresponding time span when the turn off key of the input unit 2 receives an operational input. The total playing time of each channel can be calculated according to total playing records within one day, two days, and so on. The control unit 1 further controls the playing unit 5 to play a channel listed in the channel playlist for each corresponding time span.

The input unit 2 further includes a switching key for switching between favorite channels and general channels. If the switching key is pressed, the current playing channel is switched from a favorite channel to a general channel. While playing a channel listed in the favorite channel sublist, a user can press up/down keys for switching the current channel to a former/next favorite channel listed before/following the current favorite channel listed in the favorite channel sublist. While playing a channel according to the general channel sublist, a user can press the numbered keys for switching the current general channel to a desired general channel, and can also press up/down keys for switching the current general channel to a former/next general channel listed before/following the current general channel listed in the general channel sublist.

FIG. 2 is a schematic diagram of the channel playlists generated by the channel setting system of FIG. 1. The corresponding time spans can be configured by users or automatically configured by the system. In the embodiment as that shown in FIG. 2, the corresponding time spans are configured to be one hour at three time intervals including 19:00-20:00, 20:00-21:00, and 21:00-22:00 are shown herein as an example. During a first time interval 19:00-20:00, the favorite channel sublist includes the favorite channels A2, A3, and A1, the general channel sublist includes the channels A4, A5, and so on. Furthermore, the favorite channel sublist provides a total playing time of each favorite channel listed therein, namely, 80 minutes, 60 minutes, and 50 minutes; the general channel sublist provides a total playing time of each general channel listed therein, namely, 10 minutes, 23 minutes, and so on.

During a second time interval 20:00-21:00, the favorite channel sublist includes the favorite channels A4 and A2, the general channel sublist includes the general channels A1, A3, A5, and so on. Furthermore, the favorite channel sublist provides a total playing time of each favorite channel listed therein, namely, 70 minutes and 50 minutes; the general channel sublist provides a total playing time of each general channel listed therein, namely, 20 minutes, 15 minutes, 25 minutes, and so on.

During a third time interval 21:00-22:00, the favorite channel sublist includes the channels A3 and A5, the general channel sublist includes the channels A1, A2, A4, and so on. Furthermore, the favorite channel sublist provides a total playing time of each favorite channel listed therein, namely, 60 minutes and 50 minutes; the general channel sublist provides a total playing time of each general channel listed therein, namely, 10 minutes, 30 minutes, 20 minutes, and so on.

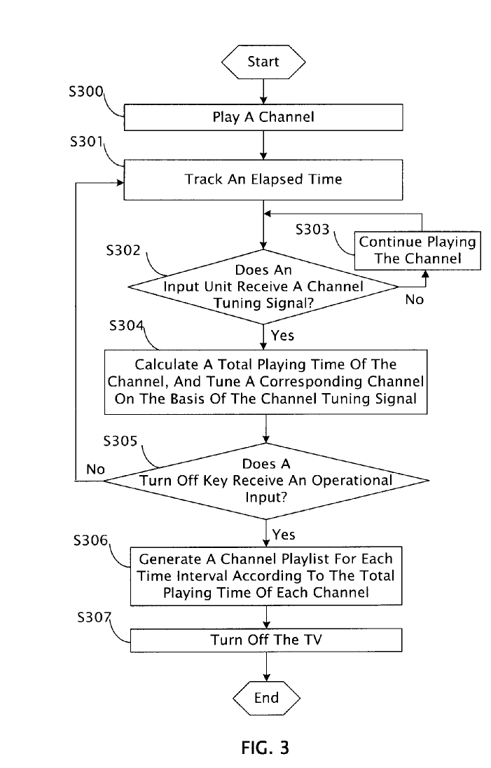

FIG. 3 is a flowchart of generating a channel playlist by implementing the system of FIG. 1. In step S300, the control unit 1 controls the playing unit 5 to play a channel. In step S301, the timer 3 tracks an elapsed time of playing the current channel. In step S302, the control unit 1 detects whether the input unit 2 receives a channel tuning signal. If the input unit 2 does not receive a channel tuning signal, in step S303, the timer 3 continues to track the elapsed time, and the playing unit 5 continues playing the channel, the procedure goes to step S302 described below. Otherwise, in step S304, the control unit 1 stores the elapsed time of the timer 3, adds the elapsed time to the total playing time of the channel, and tunes a corresponding channel on basis of the channel tuning signal.

In step S305, the control unit 1 determines whether the turn off key of the input unit 2 receives an operational input. If the turn off key does not receive any operational inputs, the procedure returns to step S301 described above. Otherwise, in step S306, the control unit 1 generates a channel playlist for each time interval according to the total playing time of each channel during each time interval. In step S307, the control unit 1 turns off the TV, whereupon the procedure ends.

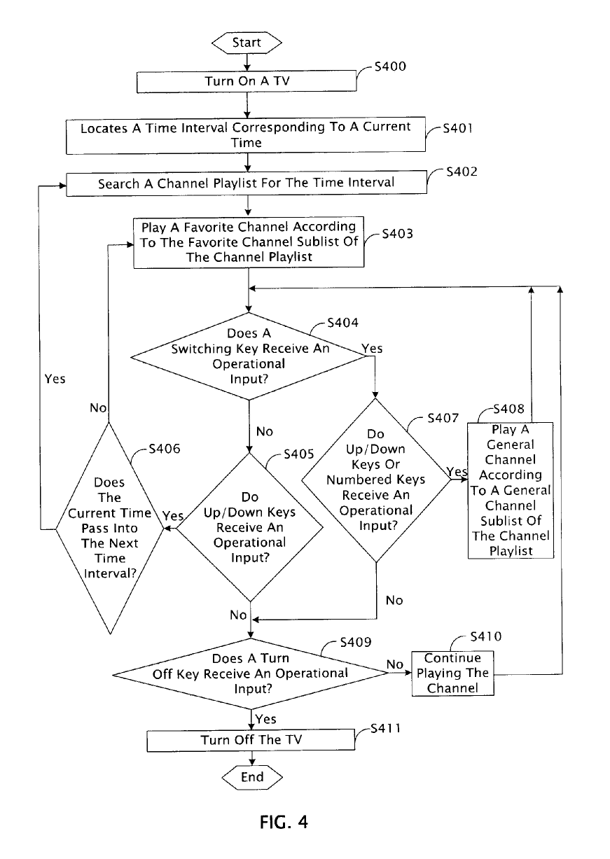

FIG. 4 is a flowchart of playing a channel according to a channel playlist generated by utilizing the channel setting method of FIG. 3. In step S400, the turn on key of the input unit 2 receives an operational input, and the control unit 1 turns on the TV according to the operational input. In step S401, the control unit 1 locates the time interval corresponding to a current time. In step S402, the control unit 1 searches for a channel playlist corresponding to the time interval located. In step S403, the playing unit 5 plays the favorite channel according to the favorite channel sublist of the channel playlist.

In step S404, the control unit 1 determines whether the switching key of the input unit 2 receives an operational input. If the switching key does not receive any operational inputs, the procedure goes to step S405 described in the following paragraph below. Otherwise, the procedure goes to step S407 described later.

In step S405, the control unit 1 detects whether the up/down keys of the input unit 2 receive any operational inputs. If so, in step S406, the control unit 1 detects whether the current time passes into the next time interval. If the current time passes into the next time interval, the procedure returns to step S402 described above. Otherwise, the procedure returns to step S403 described above.

If the up/down keys do not receive any operational inputs, the procedure goes to step S409 described below.

In step S407, the control unit 1 detects whether the up/down keys or the numbered keys receive any operational inputs. If so, in step S408, the control unit 1 controls the playing unit 5 to play a general channel according to the general channel sublist, whereupon the procedure returns to step S404 described above. Otherwise, the procedure goes to step S409 described below.

In step S409, the control unit 1 detects whether the turn off key receives any operational inputs. If the turn off key does not receive any operational input, in step S410, the playing unit 5 continues playing the current channel, whereupon the procedure returns to step S404 described below. Otherwise, in step S411, the control unit 1 turns off the TV, whereupon the procedure is ended.

Although the present invention had been specifically described on the basis of the preferred embodiment including the preferred method, the invention is not to be construed as being limited thereto. Various changes or modifications may be made to the embodiment including the method without departing from the scope and spirit of the invention.

What is claimed is:

1. A channel setting system used in an electronic device comprising:
an input unit for receiving operational inputs;
a timer for tracking an elapsed time when the electronic device is activated on a channel; and
a control unit for calculating a total playing time of each channel during a time interval according to the elapsed time of the timer, and generating a channel playlist comprising a favorite channel sublist for each time interval based on the total playing time of each channel.

2. The channel setting system according to claim 1, wherein favorite channels in the favorite channel sublist are channels whose total playing time is greater than a preset time value, and are arranged in a descending order in the favorite channel sublist, according to the total playing time associated therewith.

3. The channel setting system according to claim 1, wherein the channel playlist further comprises a general channel sublist.

4. The channel setting system according to claim 3, wherein general channels in the general channel sublist are channels whose total playing time are less than or equal to the preset time value, and are in a stochastic order.

5. The channel setting system according to claim 1, wherein the control unit searches for a channel playlist on the basis of current time interval, and switches to a favorite channel according to the favorite channel sublist of the channel playlist.

6. The channel setting system according to claim 5, wherein the input unit comprises a switching key for switching between favorite channels and general channels.

7. The channel setting system according to claim 6, wherein the control unit switches the current channel to a former/next favorite channel listed before/following the current favorite channel listed in the favorite channel sublist of the channel playlist for a time interval if the switching key does not receive any operational input and the input unit receives a channel tuning signal.

8. The channel setting system according to claim 6, wherein the control unit switches the current channel to a desired channel according to the general channel sublist if the switching key receives an operational input and the input unit receives a channel tuning signal.

9. A channel setting method performed on an electronic device, the method comprising the steps of:
tracking an elapsed time when the electronic device is activated on a channel;
calculating a total playing time of each channel according to the elapsed time during a time interval; and
generating a channel playlist comprising a favorite channel sublist for each time interval according to the total playing time of each channel.

10. The channel setting method according to claim 9, wherein favorite channels in the favorite channel sublist are channels whose total playing time is greater than a preset time value, and are arranged in a descending order in the favorite channel sublist, according to the total playing time associated therewith.

11. The channel setting method according to claim 9, wherein the channel playlist further comprises a general channel sublist.

12. The channel setting method according to claim 11, wherein general channels in the general channel sublist are channels whose total playing time is less than or equal to the preset time value, and are in a stochastic order.

13. The channel setting method according to claim 9, further comprising the step of searching for a channel playlist according a current time interval for playing a channel.

14. The channel setting method according to claim 13, further comprising the step of playing a channel according to the favorite channel sublist of the channel playlist.

15. The channel setting method according to claim 14, further comprising the step of providing a switching key for switching between favorite channels and general channels.

16. The channel setting method according to claim 15, further comprising the steps of switching the current favorite channel to a former/next favorite channel listed before/following the current favorite channel listed in the favorite channel sublist of the channel playlist for a time interval if the switching key does not receive any operational input and an input unit receives a channel tuning signal.

17. The channel setting method according to claim 15, further comprising the step of switching a current general channel to a desired general channel according to the general channel sublist of the channel playlist for a time interval if the switching key receives an operational input and an input unit receives a channel tuning signal.
